(19) United States
(12) Patent Application Publication
(10) Pub. No.: US 2012/0057679 A1
(43) Pub. Date: Mar. 8, 2012

(54) DISCHARGE MODULE FOR HIGH VOLTAGE X-RAY TUBES

(76) Inventors: Angel Diaz Carmena, Algete (Madrid) (ES); Ildefonso Moreno Vallejo, Algete (Madrid) (ES)

(21) Appl. No.: 13/260,007

(22) PCT Filed: Mar. 25, 2009
(86) PCT No.: PCT/ES2009/070073

§ 371 Date: Nov. 1, 2011

(51) Int. Cl. H05G 1/34; H05G 1/10

(52) U.S. Cl. 378/110

(57) ABSTRACT

Discharge module which is formed by three circuits, a control and measurement circuit for X-rays, a voltage division circuit between serial switches, which is independent from the previous one, and a third circuit of the charge short circuit, which in turn is formed by a successive or slave trip circuit of the switches and another main discharge circuit through the switches; due to the established configuration, a much improved radiation control is achieved as it is not affected by unforeseen agents, the short circuit current is not restricted to the port current of the switches, and residual voltage of the switches is reduced.

The object of this invention is a discharge module for high voltage x-ray tubes, which reduces soft radiation caused by the tail discharge of the filter capacities and high voltage cables.

In a conventional x ray tube, the x rays are produced by the generation of electrons through thermionic emission from a tungsten filament (cathode). The electrons are accelerated to an anode (which may be rotating to mitigate the effects of wear) in order to generate x-rays. The intensity of the tube emission is controlled by the filament current and by the difference of high voltage potential between the anode and the cathode.

An accurate control of the power supplied to an x-ray tube is important to ensure the correct image for diagnostic purposes, and to avoid unnecessary exposure of the patient to radiation from x-rays which do not produce a usable image.

The “tail” in the outlet wave form of the energy supplied produces an undesirable soft radiation which gives the patient an added dose of x-ray exposure and does not improve the image obtained. It would therefore be desirable to obtain a high voltage supply for an x-ray tube which produces substantially rectangular wave forms without a tail of undesirable soft radiations.

Therefore, this invention is circumscribed by the scope of high voltage generation equipment for x-ray tubes, and specifically within the scope of discharge modules of a high voltage cable which connects a high voltage source and an x-ray generation source.

### BACKGROUND TO THE INVENTION

To date, voltage discharge modules are known for cables which connect a high voltage supply with an x-ray generation sources such as that described in U.S. Pat. No. 5,056,125 A.

Said discharge module, although it partially achieves a reduction in the discharge tail or soft radiation, presents several disadvantages. On one hand as the voltage discharge circuits and mA measurement are not independent, the radiation control is not as accurate, as it is interfered with by unforeseeable external agents, and on the other, the discharge current of the thyristors or triacs used to reduce soft radiation is restricted to the port current that the said solid state switches are able to support.

Another difficulty of the discharge module of the previous invention is the fact that both the anode and the cathode discharge in a manner independent of an earth, therefore the discharge depends on the earth connection, and if one of said discharge connections fails, the discharge will not occur.

Therefore, the purpose of this invention overcomes the foregoing disadvantages by developing a discharge module which reduces soft radiation, in which the discharge current is not restricted to the port current which can support the solid state switches, where furthermore, the anode and cathode discharge is made in a more efficient manner and in which the voltage discharge current is separated from the mA measurement, in accordance with the topology contained in claim one.

### DESCRIPTION OF THE INVENTION

The invention of a discharge module for high voltage cables of X-ray tubes is characterised in that it includes three independent circuits.

On one hand a control circuit and X-ray measurement and on the other a voltage discharge circuit between serial switches and leak currents of the switches themselves, a circuit which is arranged independently from the mA measurement. Finally, there is a third circuit which is the short circuit of the charge formed by the actual X-ray tube and the high voltage capacities.

The short circuit of the charge circuit is in turn divided into two independent circuits, on one hand a port trip circuit of the solid state switches (thyristors, triacs etc) which is formed by a serial arrangement of serial port condensers with serial resistances, equivalent to a slave trip of serial thyristors. The second main discharge circuit which forms part of the short circuit circuit is a main discharge circuit formed by the serial arrangement of a discharge resistance and a succession of serial thyristors.

Due to the fact that the main discharge current passes directly through the actual thyristors and not through the thyristor ports or their equivalent, the discharge current is not restricted to the port current values of the thyristors.

Due to the fact that the control and measurement circuit and the discharge circuit are independent, the radiation control is much more accurate as there is no interference from leak currents caused by external agents.

And finally, due to the fact that it produces a multi-point trip, the residual line surge of the switches is reduced.

### DESCRIPTION OF THE DRAWINGS

This descriptive report is complemented by a set of plans in order to provide a better understanding of the invention, illustrating the most significant details but which is in no way restrictive of the invention.

FIG. 1, shows a general depiction of the topology of the discharge module proposed showing its main components and circuits.

FIG. 2, shows a representation of the different wave forms presented by the currents of the different circuits.

FIG. 3, shows a detail of the topology of the short circuit of the charge circuit.

### PREFERRED EMBODIMENT OF AN INVENTION

In the light of the figures below a preferred embodiment of the proposed invention is described.

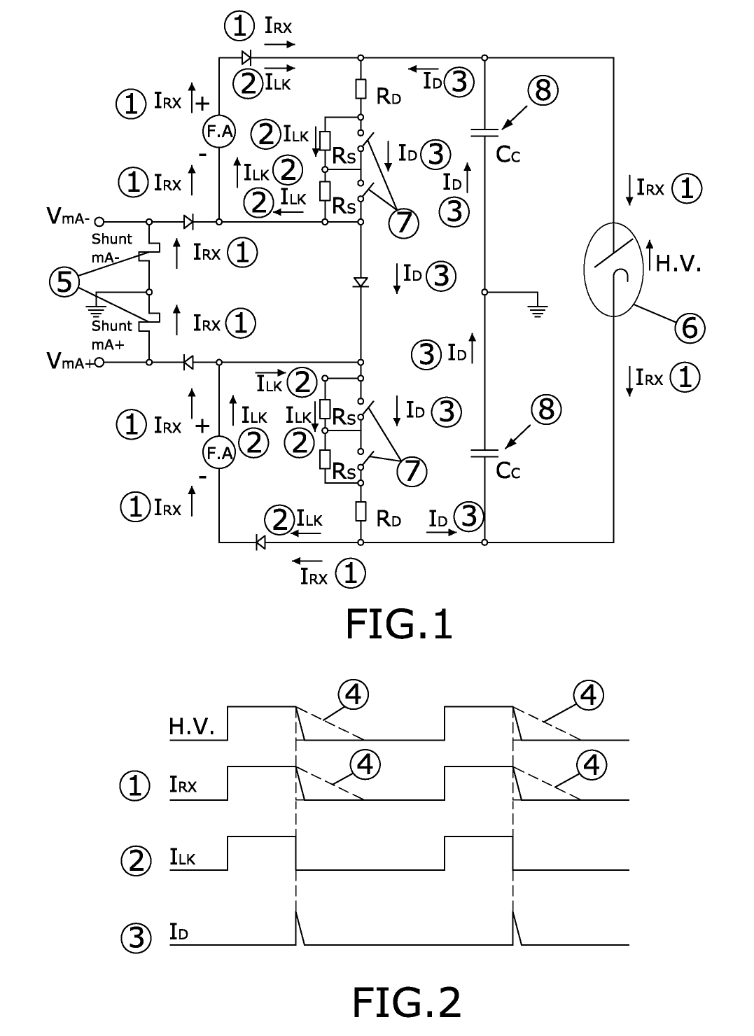

In FIG. 1, we note the topology for reducing the soft radiation due to the discharge tail of the filter capacities and high voltage cables of an X-ray tube (H.V.).

Said topology comprises three independent circuits:
The circuit (1) which is the control and measurement circuit of X-rays and through which the I_{Rx} current circulates, the current passes through two shunts (5) through diodes, through the high voltage supply sources (F.A.) and through the X-ray tube itself (6).
The circuit (2) which is a voltage division circuit between switches (7), through which the I_{LK} current circulates and which is independent from the mA measurement circuit.
The circuit (3) which is a short circuit of the charge formed by the X-ray tube itself (6) and the high voltage capacities (8).

Due to the previously described topology and the conformation of a circuit (3) short circuit, the discharge of the anode and the cathode is made in a more efficient manner, by being made from the anode to the cathode, and not from these to the earth, as occurs with the previous devices in the art.

FIG. 2, shows the wave forms of the different currents circulating through the various circuits. Thus the form of the upper wave is that of high voltage wave form, where it may seen that it has a slightly inclined discharge side however clearly cut in relation to the side (4) represented by a dotted line, which represents the wave form which would be present the voltage if the discharge circuit produced excessive soft radiation, that is, undesirable radiation because it does not serve the purpose of obtaining an image with sufficient quality, and which, however, exposes the patient to unnecessary radiations.

The following wave form represented below corresponds to the wave form of the I_{Rx} current which circulates through the X-ray tube and which presents a wave form equal to that of high voltage and which also seeks to reduce the soft radiation represented by the dotted line, up to the almost vertical side represented by the continuous line.

The following wave form corresponds to the wave form of the current which runs through the voltage division circuit between the switches (7), which presents a perfectly rectangular wave form and which is independent from the I_{Rx}current.

Finally, the last wave form shown corresponds to the wave form of the circuit of the charge short circuit, which presents a left side corresponding to the closing moment of the switches and an almost vertical right side. The more vertical the right side of the discharge current, the less soft radiation will occur.

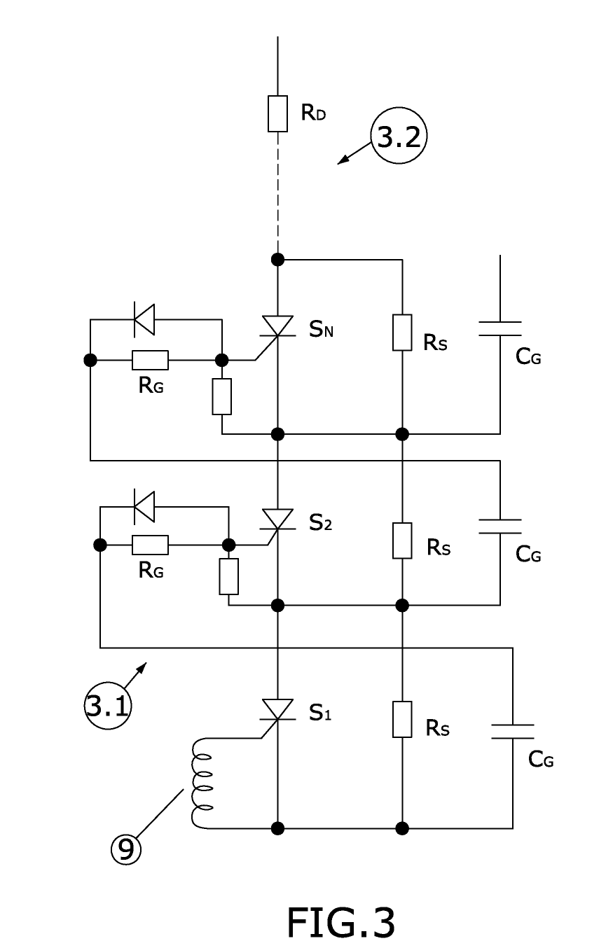

Finally, in FIG. 3, a detailed configuration of the short circuit circuit (3) is shown, in which various branches have been depicted but which, however, could reach various branches, as required, in order to obtain a voltage of, for example, 75,000 volts, which in a possible embodiment might need up to 80 branches. Said short circuit circuit (3) comprises two circuits:
A trip circuit (3.1) of the ports (C_{G}, R_{G}) of the switches, in the case shown they are thyristors, however they could be any type of switch which fulfils the purpose of switching. The first of the thyristors (S₁) trips by means of a transformer (9), then the discharge of the associated condenser C_{G} begins through the port of the second thyristor S₂, through which the second thyristor trips, such that as the second thyristor S₂ is activated, the associated C_{G} condenser discharge begins through the port of the third thyristor and so on successively. A slave trip of connected thyristors is produced, that is, successively. Due to the multipoint trip, residual surge of the switches is reduced.
A second main discharge circuit (3.2) formed by the succession of R_{D}, S₁, S₂, . . . , S_{N}. The advantage of this configuration is that the discharge current is not restricted to the port current of the switches.

The essential nature of this invention is not altered in any way by variations in materials, form, shape and arrangement of the component elements which are described in a manner which is in no way restrictive but which is sufficient for an expert to proceed to its reproduction.

1. Discharge module for high voltage cables of X-ray tubes characterised in that it comprises three independent circuits:
A control circuit (1) and measurement of X-rays and through which the I_{Rx}, current circulates.
A circuit (2) which is a voltage division circuit between the switches (7), through which the I_{LK} circulates.
A circuit (3) which is a short circuit of the charge formed by the X-ray tube (6) and the high voltage capacities (8).

2. Discharge module for high voltage X-ray tubes according to claim 1 characterised in that the short circuit (3) of the charge circuit is formed by two circuits:
A trip circuit (3.1) of ports (C_{G}, R_{G}) of the switches,
A second main discharge circuit (3.2) formed by the serial succession of R_{D}, S₁, S₂, . . . , S_{N}.

3. Discharge module for high voltage cables of X-ray tubes according to claim 2 characterised in that the switches are solid state switches such as thyristors, triacs, etc.

4. Discharge module for high voltage cables of X-ray tubes according to claim 2 characterised in that the trip of the solid state switches is produced successively.
